(19) United States
(12) Patent Application Publication
(10) Pub. No.: US 2009/0152227 A1
(43) Pub. Date: Jun. 18, 2009

(54) Recoverably Installable Vehicle Lifting Hoist - Method and Apparatus

(76) Inventors: Scott R. Thompson, Dickinson, ND (US); Veronica Rodriquez, San Antonio, TX (US)

Correspondence Address: REALTRONICS CORPORATION;SCOTT R. THOMPSON, P.O. BOX 906, DICKINSON, ND, 58639, US

(21) Appl. No.: 12/044,944

(22) Filed: Mar. 8, 2008

Related U.S. Application Data
(60) Provisional application No. 61/013,571, filed on Dec. 13, 2007.

(51) Int. Cl. B66C 23/04; B66C 23/00

(52) U.S. Cl. 212/348; 212/347; 212/270

(57) ABSTRACT

Embodiments of a method and apparatus to lift payloads onto or into a vehicle are disclosed. Optimal embodiments of the device mount to a plurality of receiver hitches on a vehicle and combine optimally shaped and positioned structures, rigid and flexible linkage, and a pivoting tower to form a lifting hoist that is foldable, retractable, and can be recoverably installed. A prominent feature of the present invention is the ability to retract to a stored position that does not interfere with other features or functions of the host vehicle. This invention includes components that make it safe to use on un-level surfaces and other components and methods that enable the apparatus to be leveled to some extent before use.

### CROSS REFERENCE TO RELATED APPLICATIONS

This application claims the benefit of priority under 35 U.S.C. 119(e) to provisional application No. 61-013571 filed Dec. 13, 2007 and titled “Rear-Vehicle Lifting Hoist—Method and Apparatus”.

### STATEMENT REGARDING FEDERALLY SPONSORED RESEARCH

None

### FIELD OF THE INVENTION

The field of this invention relates to foldable vehicle lifts that are easy to install, use, and recover.

### BACKGROUND OF THE INVENTION

This invention teaches improvements to methods and apparatuses that address the on-going ubiquitous need to conveniently load heavy items into vehicles. Prior art abundantly teaches costly and bulky lifting devices that are permanently or semi-permanently installed into the floor, frame, roof, sides and other structurally sound areas of a vehicle. Williams teaches a preferably telescoping lift that raises and lowers a platform in U.S. Pat. No. 6,726,435. Dahl teaches a similar yet larger platform in U.S. Pat. No. 6,655,895 that engages a substantial structure of a vehicle to increase load capacity. A more robust platform lift and enclosure is taught by Dorn in U.S. Pat. No. 5,674,043.

Farsai teaches a permanently installed wheelchair platform lift in U.S. Pat. No. 5,433,581 that lowers to receive a wheelchair from the surface and raises the chair to the floor level of the vehicle so that a person can be rolled into the vehicle. U.S. Pat. No. 6,585,474 teaches a wheelchair platform lift that is foldable into a stowed state. A smaller scale platform hoist intended principally for personal mobility scooters is taught by Williams in U.S. Pat. No. 6,726,435. U.S. Pat. No. 6,783,315 teaches a platform hoist that is mountable into a receiver hitch and uses a vehicle frame mounted structure to control pivoting action of the platform.

Kelso teaches a lift that raises a person so that the individual can more easily access a wheel chair in U.S. Pat. No. 7,055,840. By contrast, Romero teaches an apparatus that lifts a wheelchair to a person in U.S. Pat. No. 6,851,751. Carpenter teaches a hydraulic lift installable in a van that uses a pivotable frame to move a load in U.S. Pat. No. 4,121,695. Vartanian teaches a lift that uses components arranged in a parallelogram like structure to lift objects in U.S. Pat. No. 6,309,170.

A design taught by Kytola in U.S. Pat. No. 5,553,990 enables placement of a wheelchair in an enclosing cage as it is lifted into a vehicle. Ablabutyan teaches permanently mounted lifts that hoist a wheel chair bound passenger into a vehicle in U.S. Pat. Nos. 6,705,824 and 6,461,097. DuBose also teaches a lift designed to hoist a wheelchair bound person into a vehicle in U.S. Pat. No. 6,513,824.

Crain teaches a Wheelchair lift that replaces the driver seat so that a handicapped person can drive from his wheelchair in U.S. Pat. No. 5,308,214. Tauer teaches a wheelchair lift having a single piston and cylinder mechanism that mounts under a van for both raising and lowering in U.S. Pat. No. 6,089,817. Nelson teaches a removable and collapsible crane with a permanently installed base in U.S. Pat. No. 5,090,580.

Brooks teaches a foldable hoist with a pivot at the base that allows the crane to fold into a highly compact state in U.S. Pat. No. 3,854,594. The hoist is permanently affixed to the frame of the hoist vehicle and uses a hand-winch to elevate a load. Bechler teaches a scooter lift in U.S. Pat. No. 5,853,282 that installs onto the floor of a storage area of a transport vehicle. Likewise Mann teaches a wheelchair lifting apparatus that is mounted to the floor of a vehicle in U.S. Pat. No. 4,127,200. Riley teaches a similar device intended to be mounted to the chassis of a vehicle in U.S. Pat. No. 4,406,574.

U.S. Pat. No. 4,419,038 teaches a bumper mounted lift with a primary horizontal support structure affixed to the vehicle chassis preferably below the rear edge of the load bed. Lin teaches an attachment for the rear portion of a vehicle for transporting a personal mobility vehicle that mounts under the frame of a vehicle in U.S. Pat. No. 5,205,700. Peterson teaches a permanently installed lift for transporting principally motorized carts in U.S. Pat. No. 5,431,526.

The foregoing and others including U.S. Pat. Nos. 3,952,893, 3,972,433, 4,024,971, 4,221,528, 4,269561, 4,274,788, 4,398,858, 4,604,022, 4,685,860, 4,725,183, 5,232,329 are representative examples of a class of permanently installed lifts that help move inanimate objects, disabled persons, wheelchairs, or powered mobility devices into a vehicle. While adequate for lifting purposes, this category of hoist faces market barriers that include high installation costs, vehicle alteration, and non-recoverable installation.

This invention improves the foregoing by teaching a recoverable means to engage a lifting apparatus to a host vehicle. Samples of similar prior art teach methods to engage a lifting hoist via a bumper, ball hitch, or receiver hitch; most embodiments suffer unique drawbacks that limit market participation. For example, Canadian Patent 2,108,107 teaches recoverable installation of a hitch hoist that weighs 125 pounds and must be assembled, mounted and removed during each use. U.S. Pat. No. 6,830,875 teaches a lift that uses a ball hitch to stabilize a portable lift. The lift unfolds into a complex tri-pod that must be setup on the ground adjacent to the host vehicle.

U.S. Pat. No. 6,007,289 teaches an apparatus that mounts into a receiver hitch and uses a jig to stabilize and increase the lifting capability of the hoist. The '289 patent teaches a design that is simple and advantageous in terms of cost. Owing to a high rotational pivoting point, the Kruse lift includes a hoist assembly removably coupled to a boom assembly. The hoist assembly must be partially disassembled to enter a folded state and reassembled when returned to an operative state. The stanchion and jig share a common folding point that forces the jig to extend beyond the dimensions of the hoist and possibly of the host vehicle. The location of pivoting and folding points also causes the Kruse hoist to fold into a retracted state that can interfere with tailgate and hatchback operation.

U.S. Pat. No. 5,749,697 is a multi-purpose hoist, taught by Davis, that also bends in the middle and consequently the lift requires assembly during each use. However, the Davis patent teaches a hoist that is easily taken a part for transportation and storage. The '697 patent further discusses how the top and bottom components mate together during use and are easily disassembled afterwards. The hoist taught in the '697 patent is not a foldable crane.

Barger teaches a lightweight portable crane with safe attachments that is easily assembled and disassembled during each operation. The device is adaptable to shop work benches and other areas as well as multiple vehicles in the service industry. It is well suited for its intended applications; however, the device suffers many of the previously noted drawbacks. The hoist does not easily fold into a stowed state. By contrast, the Barger hoist requires complete assembly before each use and complete disassembly and removal after each use.

U.S. Pat. No. 4,746,263 teaches a bumper mounted hoist that uses a single cable to unfold the hoist and further to lift loads that are operationally coupled to it. U.S. Pat. No. 5,114,120, teaches a vehicle mounted hitch that swings away from the opening of a vehicle during operation and further prevents operation of the hoist when it is not in an operable state to prevent personal injury and damage to the vehicle.

Amato teaches a swingable boom-type portable crane that engages the receiver hitch of a vehicle. A foot on the lower end of the sanction is retractable to allow the hitch to transport a load in tow. The non-collapsible sanction is fully pivotable and can be disassembled between uses. U.S. Pat. No. 5,752,799 discloses a recoverable hoist for transporting recreational vehicles. The hoist taught by Carey uses a single folding point elevated above the loading surface of the vehicle. Harr teaches a similar lift in U.S. Pat. No. 5,993,137 that uses a single folding point provide movement intended largely to lift engines. The hoist taught in the '137 patent must be removed from the vehicle after each use. Williams teaches a portable mobility device hoist in U.S. Pat. No. 6,830,423 that uses a pivot limiter to restrict movement that could lead to vehicle damage or personal injury. The '423 patent teaches a lifting apparatus with a winch that is recoverably installed during each use.

A lift that uses a single pivoting point to hoist large sized loads is taught by McVaugh in U.S. Pat. No. 6,042,328. The '328 patent is stowable along the upper rim of a truck bed. Compton teaches a collapsible hoist in U.S. Pat. No. 6,152,675 that has a sufficiently high center mast to elevate hunting game; the hoist is assembled, installed, and subsequently removed between uses. A collapsible hoist taught by Perkins in U.S. Pat. No. 6,578,722 also engages a vehicle receiver hitch and has a telescoping mast that is able to achieve a sufficient height to raise tall objects. Phillip and Angel teach similar game hoists in U.S. Pat. Nos. 6,705,821 and 7,201,552. Like the '675 patent, the '522, '722 and '821 patents teach cranes that do not pivot.

O'leary teaches a platform scooter lift that engages a vehicle receiver hitch in U.S. Pat. No. 6,887,027. The '027 patent teaches a device that includes safety features that prevent the platform from tilting if a load is detected. Other recoverably installed hoist teachings include U.S. Pat. Nos. 4,412,635, 5,038,983, 5,211,526, 6,830,423, and 7,201,552.

Spinosa teaches a lifting system for removing and installing equipment on aircraft. The lifting system comprises a base, a lifting assembly, a plurality of linear outriggers and at least one offset outrigger. Like the present invention U.S. Pat. No. 5,758,785 teaches a boom that is tilt-able about a horizontal axis relative to the base and rotated about a vertical axis relative to the base for increased maneuverability. Unlike the present invention, the '785 patent teaches a self-contained lift. More importantly the lift is not adaptable to a vehicle which is a primary aspiration of the present invention. The system requires minimal assembly as the outriggers are detachably connected to the base and the lift includes a detachable towing fixture. Spinosa teaches a telescoping mast adaptable to various loads and various applications.

### BRIEF SUMMARY OF THE INVENTION

This invention teaches a lightweight retractable lifting hoist that is recoverably installable into a vehicle insert and preferably a receiver hitch. This invention improves prior art by teaching methods and embodiments that mitigate interference with any feature or function on the host vehicle. A principal novelty of the present folding crane over prior art is the ability to use various types of linear actuators to provide lift while the hoist retains the capacity to fold into a compact and non-interfering state. A number of hoists employ linear actuators and a number of hoists teach methods to fold into a stowed state. Owing to suboptimal placement of pivoting and folding points; nothing found in prior art delivers both features. The present invention accomplishes this through optimal placement of pivoting and folding points throughout the hoist and particularly to accommodate engagement of long actuators to pivoting structures on the hoist.

This invention further improves prior art by teaching placement of pivotal points and structures that enable components thereof to fold into a retracted state that preferably does not extend beyond the physical dimensions of the host vehicle. This invention teaches improved means to level the hoist, to enable safe hoist operation on uneven surfaces, and to fold and secure the hoist into an unobtrusive state when not in use. An important benefit of this invention over prior art is that lifting components and other attachments do not need to be removed as the device is folded and unfolded.

While providing for a more compact hoist, the foregoing also gives a novel capacity to adaptively use sources of mechanically powered actuation spanning hydraulic, pneumatic, electric, and mechanical linear actuators as well as springs, coils, cables, winches, ropes, and straps. This feature enables the invention to be accessorized with various components suitable for various applications. The present invention addresses this problem by horizontally pivoting the lifting apparatus into a low profile when it is in a retracted state. The methods, apparatuses, and embodiments taught herein are scalable and are well suited for any lifting purpose.

### DESCRIPTION OF THE DRAWINGS

Further features, advantages, and benefits of this invention, as well as the structure and operation of various embodiments thereof, are described in detail below with reference to the accompanying drawings. In the drawings, like reference numbers generally indicate identical, functionally similar, and/or structurally similar elements. The drawing in which an element first appears is indicated by the leftmost digits in the corresponding reference number. The drawings disclosed herein are illustrative of preferred and sample embodiments of the disclosed invention and are not intended to limit the spirit or scope thereof.

FIG. 1 is a preferred embodiment of present invention that employs a hand-pumped hydraulic jack to induce vertical movement.

FIG. 2 illustrates various mechanically powered accessories that can be adaptively installed and used to provide lift with the present invention.

FIG. 3 is an exploded view of preferred embodiments of the present invention that employs a hand-pumped hydraulic jack to induce vertical movement.

FIG. 4A shows how retaining pins can be used to lock moving components of the present invention in place.

FIG. 4B shows a latch that can be used to lock moving components of the present invention in place.

FIG. 4C shows a hook style latch that can be used to lock moving components of the present invention in place.

FIG. 4D shows a quick release style latch that can be used to lock moving components of the present invention in place.

FIG. 5 illustrates a mechanical means to induce vertical movement in a supporting jig that extends to the ground.

FIG. 6A illustrates a mechanical means to use a motor and chain drive assembly to cause a gear-linked hoist apparatus to unfold.

FIG. 6B illustrates a mechanical means to use a motor and worm-gear drive assembly to induce pivotal movement along a primary axis on the hoist.

FIG. 6C illustrates a mechanical means to use a motor and chain drive assembly to induce pivotal movement along a primary axis on the hoist.

FIG. 7 illustrates a preferred embodiment that uses linear actuators and electric motors to induce movement throughout the hoist.

FIG. 8 is an alternative embodiment that combines square tubes and round tubes with other geometrically shaped mechanical segments to form the lifting apparatus.

FIG. 9 illustrates a method to use wireless remote to cause a preferred embodiment of the present invention to lift a powered mobility device into a vehicle.

FIG. 10 illustrates a method to use a preferred embodiment of the present invention to lift a portable cart into a vehicle.

FIG. 11 illustrates a method to combine a receiver hitch tray and dual receiver hitch adapter with an embodiment of the present invention to transport a personal mobility device on a vehicle that has limited storage space.

FIG. 12 illustrates a method to use a preferred embodiment of the present invention to transfer an internal combustion engine into a vehicle.

FIG. 13 illustrates a method to use a preferred embodiment of the present invention to lift a pallet and cargo onto a truck.

FIG. 14 illustrates a method to use a preferred embodiment of the present invention to lift an all terrain vehicle onto a truck.

FIG. 15 illustrates a preferred embodiment of a safety chain mounting assembly at the receiver hitch engagement point of the lifting hoist.

FIG. 16 illustrates an adapter that can be used to tightly secure the present invention to a vehicle insert.

FIG. 17 illustrates an adaptive means to engage the present invention to the side of a vehicle.

FIG. 18 shows exemplary vehicle insert embodiments usable with the present invention to allow lateral and longitudinal position adjustment of the hoist to avoid contact with the host vehicle.

FIG. 19 shows an exemplary mechanical actuator usable with the present invention.

### DETAILED DESCRIPTION OF PREFERRED EMBODIMENTS

The present invention is a retractable lift optimally engaged to a vehicle insert and capable of folding into retracted and operational states. The term “vehicle insert” refers herein to device on a vehicle that is sized and shaped to receive the present invention; a common example thereof is a receiver hitch. With proper placement of vertical and horizontal pivoting points, the present invention is able to fold into a compact state that does not interfere with or extend beyond the sides the host vehicle. The term “locks” refers herein to latches, pins, hooks, clamps, links, and other structures that are releasably engaged to control pivotal movement throughout said lifting apparatus.

Exemplary embodiments use mechanically powered hydraulic, electric, or pneumatic actuators to induce load and hoist movement. The phrase “mechanically powered” is used herein to specify powered mechanical methods to induce movement such as hydraulic, electric, pneumatic, magnetic, mechanical leverage, and tension as well as future methods that become available to induce movement. By definition herein, the term includes electric motors.

The present invention is adaptively accessorized to enable human and mechanically powered embodiments to use combinations of the foregoing as well as flexible means such as springs, coils, cables, cable winches, chain hoists, ropes, and straps to induce movement or to couple this invention to a load. Other means such as hooks, grasps, tongs, custom connectors and the like are adaptively used to couple a load to this invention. Preferred embodiments of the present invention are best understood by referring to the drawings.

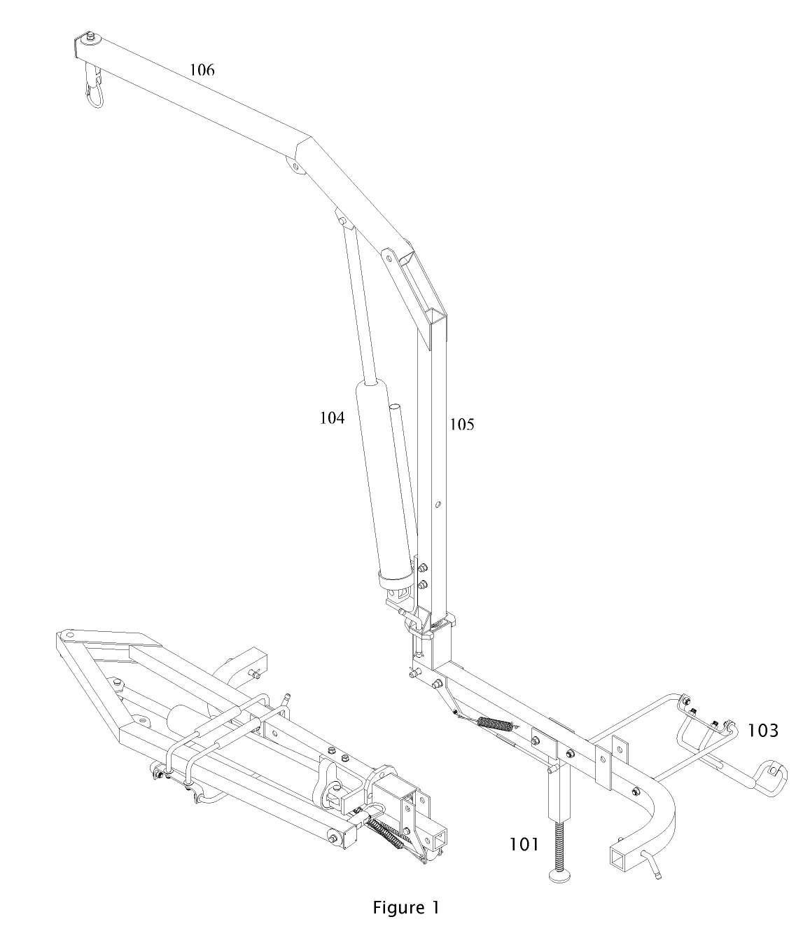

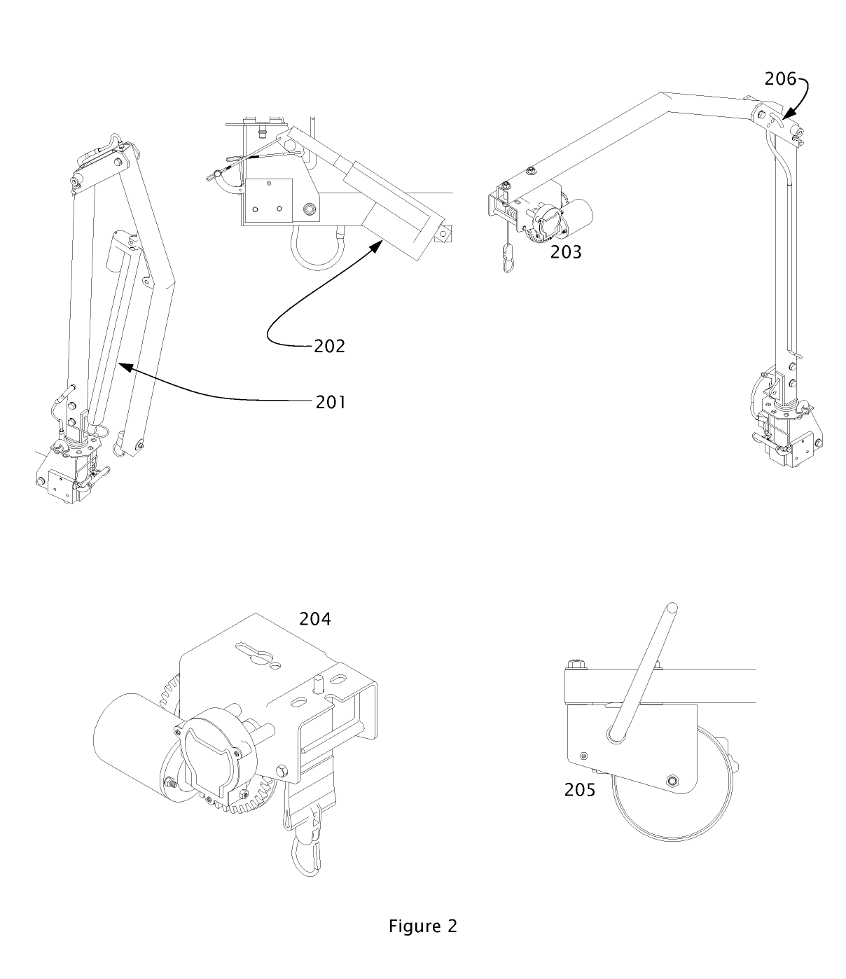

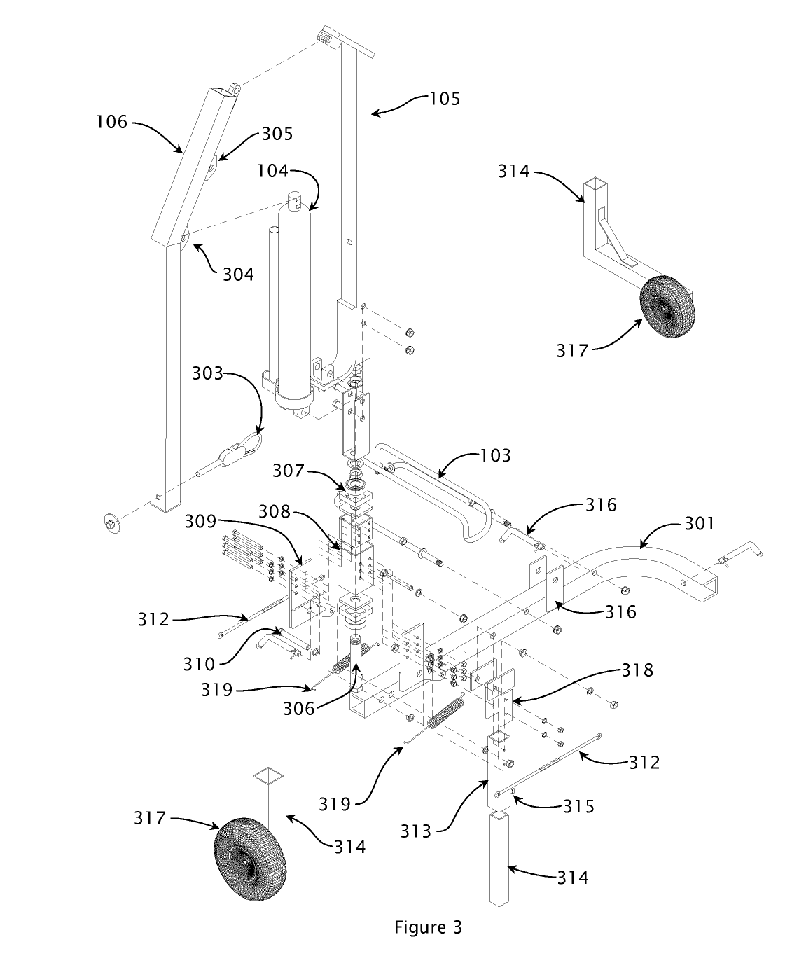

FIG. 1 shows how an exemplary embodiment uses a hand-operated hydraulic jack to induce mechanically powered movement. The embodiment of FIG. 1 is depicted in a folded (shown left) and unfolded (shown right) state. Various components of an alternative embodiment, shown in expanded detail in FIG. 3, mount to a base support structure 301 that engages a vehicle insert or other similar apparatus. Notice in the exemplary embodiment of FIG. 3 that nut and bolt assemblies are used in place of welding methods like those depicted in FIG. 1 to affix various components of the apparatus to one another.

The exemplary embodiment of FIG. 1 demonstrates how a hydraulic linear actuator 104 is pivotally affixed to a vertical mast 105 and a lifting arm 106 that includes a hook 303 or other means to grasp a load. Alternative embodiments use linear actuators 104, 201, 1901, cable winches 203, strap winches 204, hand-cranked winches 205, and other means to induce lifting motion throughout the hoist. The lifting arm can optimally include multiple clevis points 304 and 305 to enable the hoist to support heavier loads. Gussets and other structures and geometries are preferably used to enhance the strength of the lifting arm as warranted by individual intended applications.

The vertical mast connects to a pivoting axle 306 and bearings 307 that enable the hoist to swing a load to and from any point that is within the operational range of the apparatus. The pivoting axle 306 and bearings 307 are affixed to a pivoting assembly comprised of various structural components 308 and 309 that enable the vertical mast to raise and lower from a retracted position. A bolt or other axle assembly 310 affixes the structural components 308 and 309, axle 306 and bearings 307, and vertical mast 105 to the base support structure 301. In consideration of design trade-offs, larger diameter pivoting assemblies can be used to reduce the overall height of the hoist.

Springs 319 optionally provide lifting assistance in the embodiment of FIG. 3 as the apparatus is manually unfolded. Other embodiments alternatively use compressed gas springs, linear actuators 201, hydraulic or pneumatic cylinders 104, mechanic actuators 1901 or any other mechanical means in place of the springs 319 to unfold the apparatus. Embodiments that are intended for heavy use may use a single mechanical drive and a turnbuckle 312 or other linkage to cause a supporting jig 313, 314 to extend downward as the vertical mast is unfolded upward. Other embodiments provide independent folding operation of the jig relative to the hoist. Lip-latches 404, pins 206, 401, hooks, clamps, links 403, other structures 402, and quick release latches 405 are preferably used to control or lock pivotal movement throughout the hoist.

Mechanical means including the use of chains 601, gear patterns 602, structural links, belts, mechanically powered devices, and the like may be used to cause the jig 313 and lifting structure 105 to simultaneously extend away from the base support structure 301. The supporting jig 313 includes an ancillary segment 314 that uses any means to extend or retract to accommodate changes in distance between the lifting apparatus and the ground or other supporting surface beneath the host vehicle. The ancillary segment 314 is preferably used to level the base support structure 301. The supporting jig 313, 314 is preferably missing or left in a retracted state that does not come into contact with the surface below when sufficiently light loads are lifted by this invention.

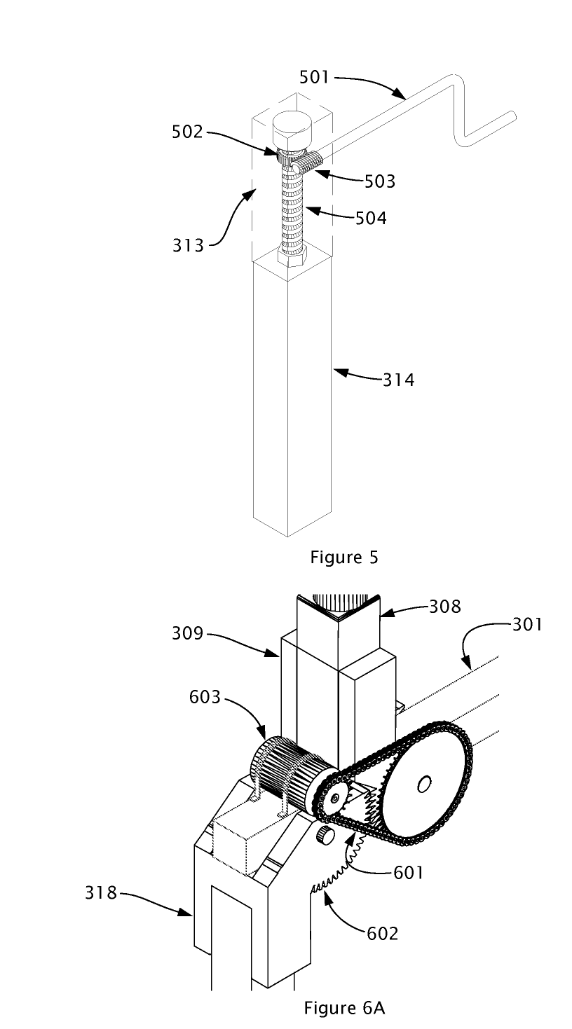

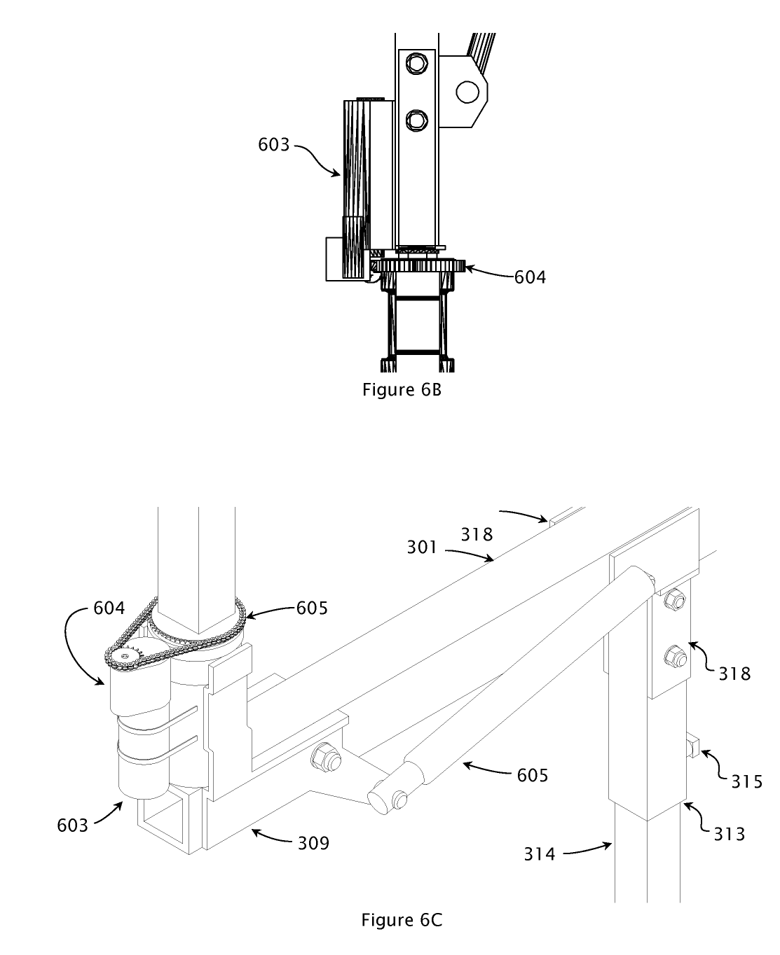

Preferred methods to induce movement in the ancillary segment 314 include hand-operated gear reduction 501 and 502, worm-gear drives 502, linear actuators, augers 504, rigid or flexible linkage, hydraulic or pneumatic methods, and other mechanically powered means. For example some embodiments may combine many of the above components with other components to induce vertical movement in the jig 314 as shown in FIG. 5. Still other embodiments may use an auger in place of the ancillary segment 101 as shown in FIG. 1. A simplified embodiment relies on human or other forms of induced movement and uses a crimping bolt 315 or other crimping method to hold the jig 314 in place as shown in the drawings. Retaining pins will also hold the jig 314 in place.

The ancillary segment 314 may include a wheel 317 to enable this invention to carry a load in tow with a host vehicle preferably over short distances. Some embodiments may include a bend and a horizontal extension in 314 to position a plurality of wheels 317 below the load during tow. In most embodiments a plurality of mounting plates 318 are welded to the supporting jig 313. In the preferred embodiments the mounting plates are pivotally affixed to 301 to enable the jig assembly to fold and unfold. The supporting jig 313 and ancillary segment 314 may not be present in some embodiments and particularly those that are intended for light loads.

An optional safety apparatus for this invention is the jack retaining assembly 103 shown in the figures. The retaining assembly may be held in place by a clevis and pin assembly 316, latch, springs, or any other means.

Adaptive embodiments of this invention may engage the side of a vehicle 1701 to load a personal mobility device 901. Other adaptive embodiments may be placed throughout a vehicle as needed for various applications and to clear existing components of the host vehicle. Doing so may require adaptive vehicle inserts 1702, 1801 capable of receiving embodiments of the present invention and adjusting the position thereof. For example 1702 may be needed to position a vehicle insert to the side of a van as illustrated in FIG. 17. Likewise 1801 may be required to allow lateral position adjustment of the hoist to avoid components of the vehicle body, door openings, and tailgate movement.

### PREFERRED METHODS

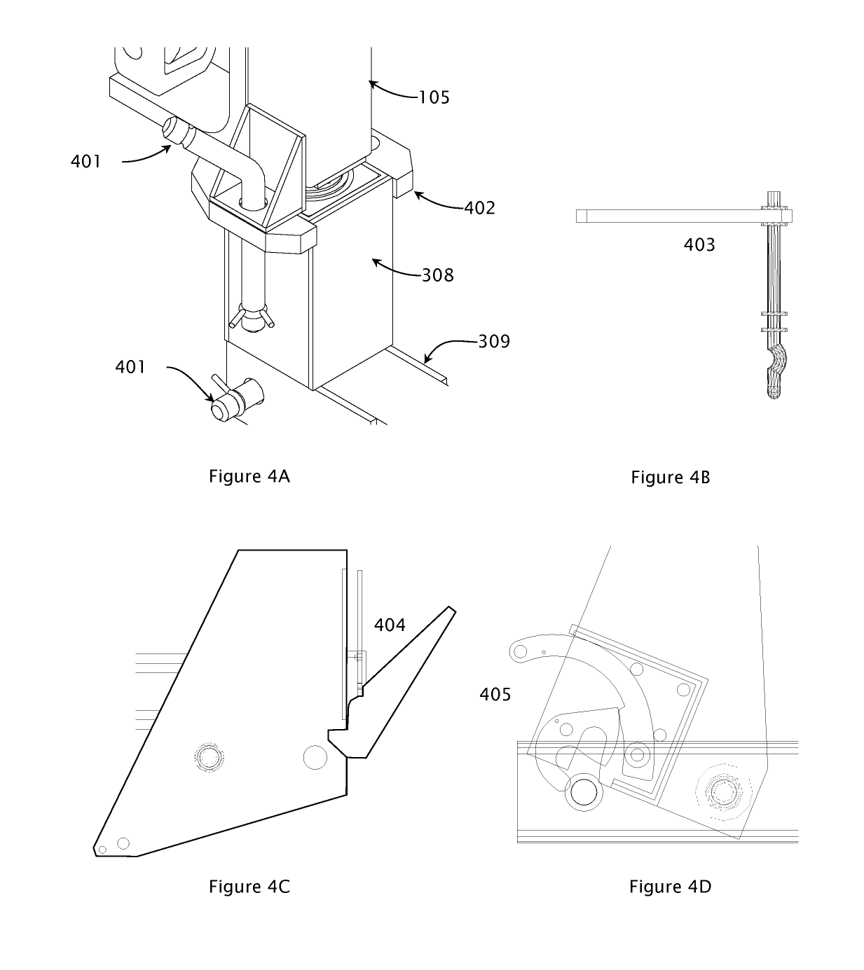

It is important to use this invention on a level surface to minimize the threat of damage to the hoist, host vehicle, or payload and further to impede the threat injury to the hoist operator. If this invention is used on an uneven surface, a preferred method to level the hoist employs a level indicator and an extending jig or other assembly like that shown in FIG. 4. If a load must be lifted from an uneven or un-level surface, a preferred method to prevent damage or personal injury is to secure the rotating pivot with a retaining pin 401 and mast collar 402.

Select methods combine gravity or other means to cause the retaining pins 401 or other similar structures to automatically engage the mast collar or other fixed structure on the hoist to impede pivotal motion; particularly when the apparatus is used on an un-level surface. Various combinations of sensors or limit switches are preferably combined with this invention to autonomously control the position of the hoist in order to prevent damage to the hoist, host vehicle, payload, and the person operating the hoist.

Another safe recommended method of use is to engage retaining chains 1501 between the hoist and the host vehicle 1502. The retaining pin 1603 is also preferably tightly fit into the vehicle insert 1502. A preferred embodiment includes quick-latch components to engage a plurality of chains 1501 to the hitch and the vehicle 1502. FIG. 16 illustrates an optional assembly that will further mitigate the threat of damage to this invention or to the host vehicle. The assembly uses a wedge 1602 and a threaded bolt 1603 to tightly secure the engagement point 1601 to the receiver hitch.

### EXEMPLARY USES OF PREFERRED EMBODIMENTS

An important market application of this invention is to provide disabled persons with a means to place hand operated and powered wheel chairs into vehicles that are not large enough to house conventional chair-hoists. Accordingly preferred embodiments of this invention eliminate or mitigate the need for human involvement during load transfer. Some embodiments use motor 603 and chain drives 601 while others use worm-gear drives 604 to initiate pivotal movement.

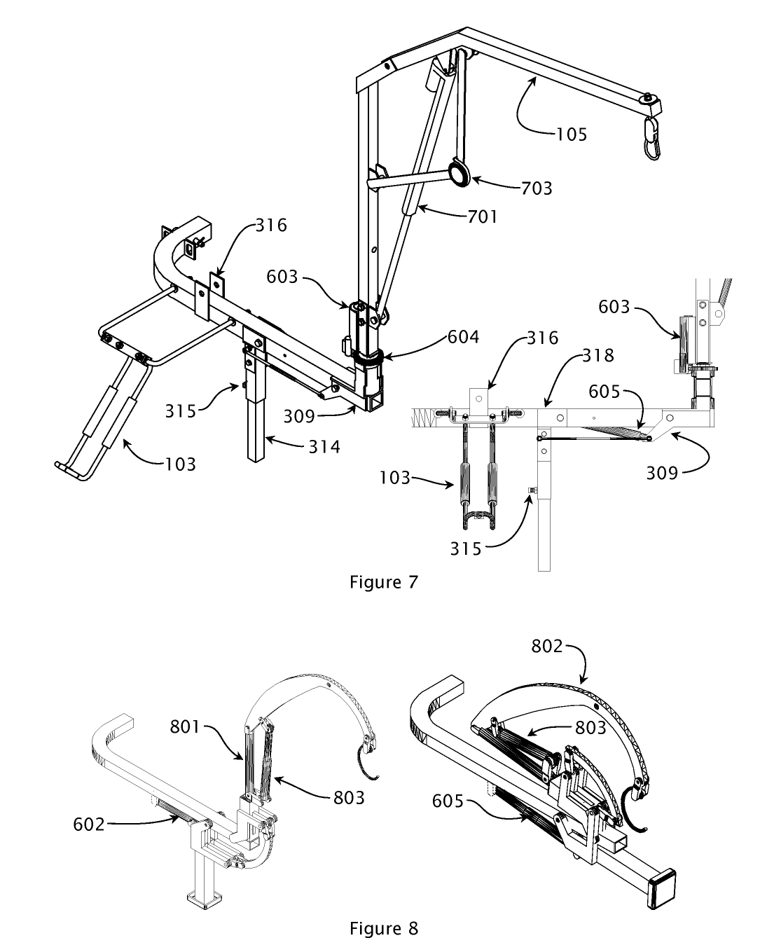

The sample embodiment shown in FIG. 7 combines the foregoing with linear actuators 701, 605, coil or other springs 703, and gear-reduced servo motors 603 to induce motion throughout the hoist. An alternative embodiment that uses hydraulic actuators 803 to induce movement throughout the hoist is shown in FIG. 8. Unlike the previously illustrated embodiments 801 and 802 are not fabricated from conventional square tubing. When cost becomes important, select embodiments of the present invention may rely on mechanical actuators 1901 to induce movement.

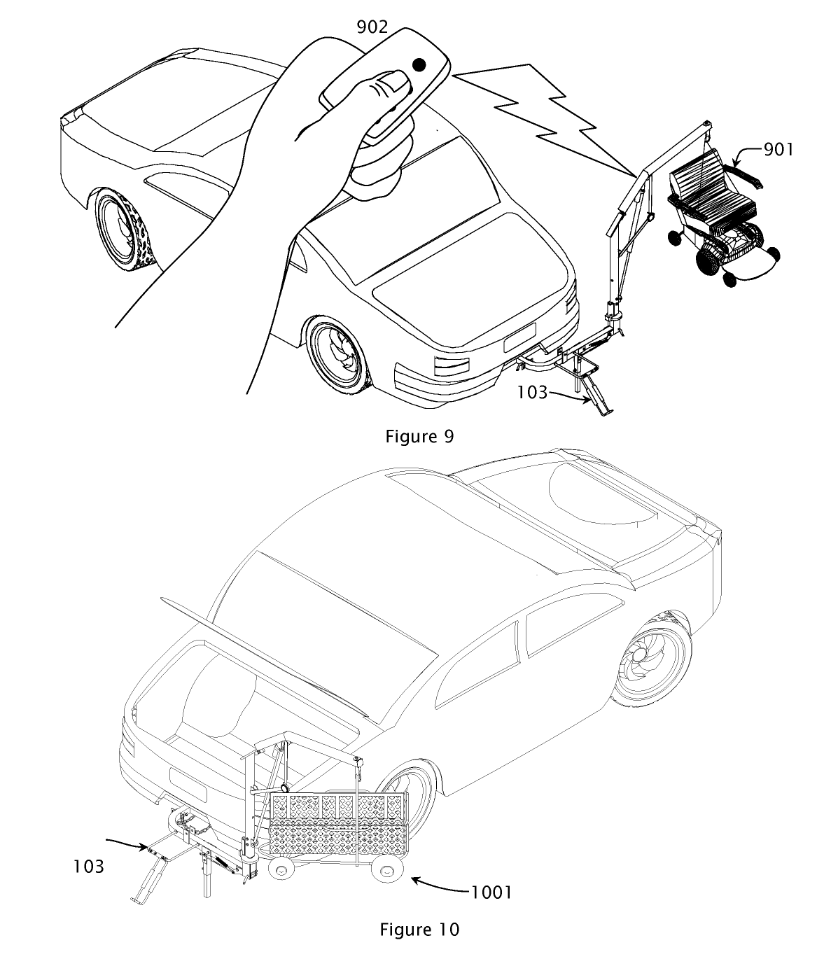

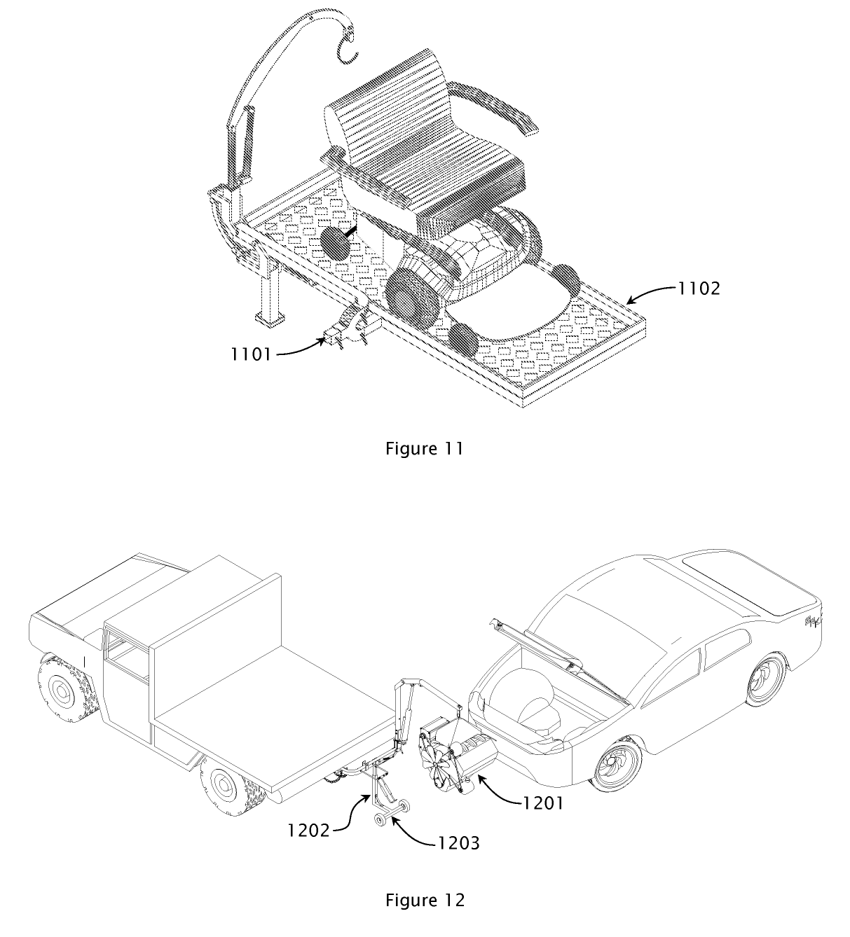

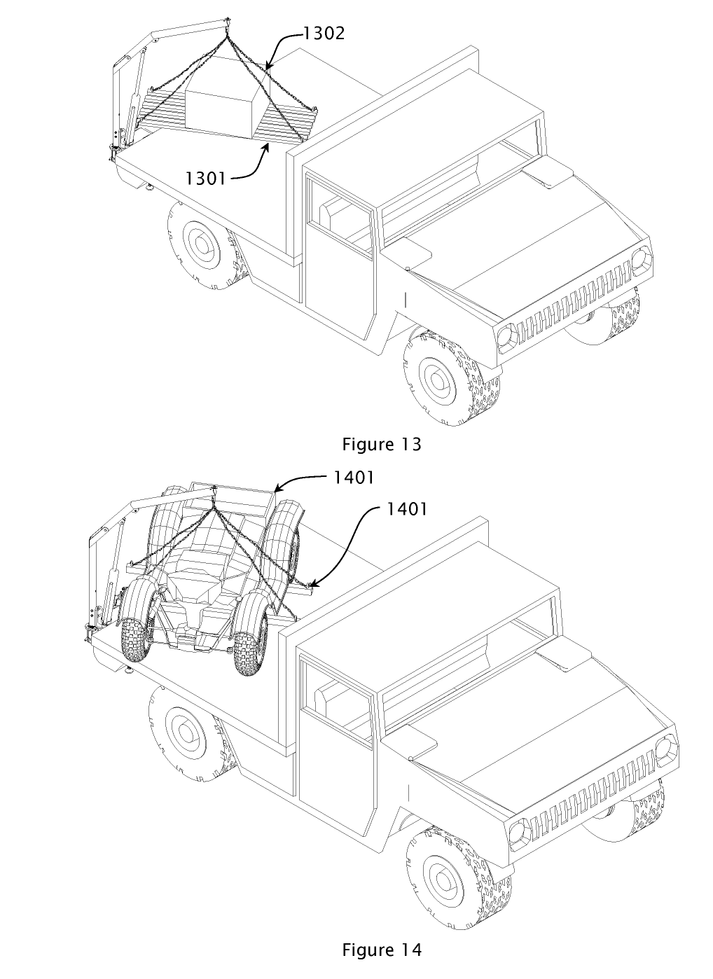

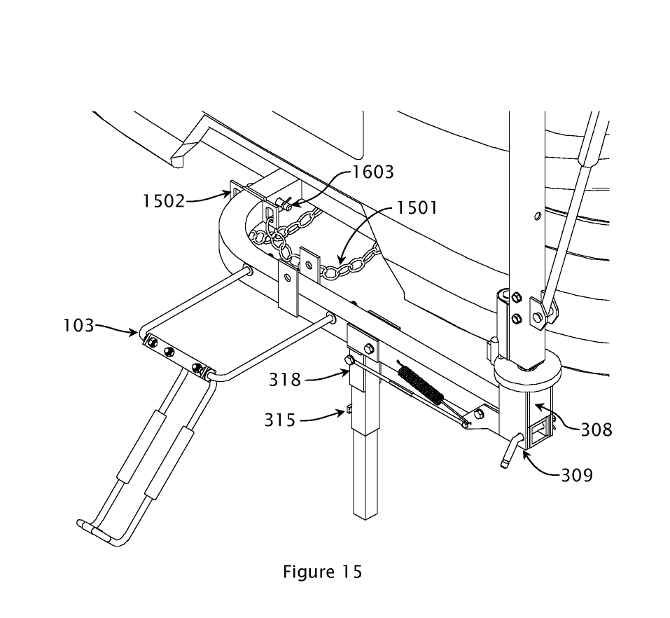

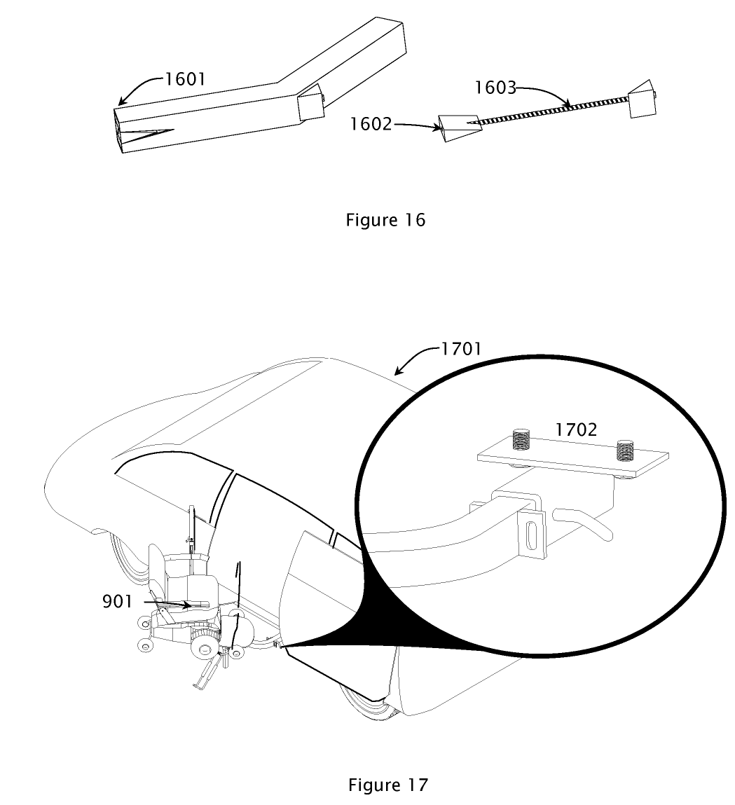

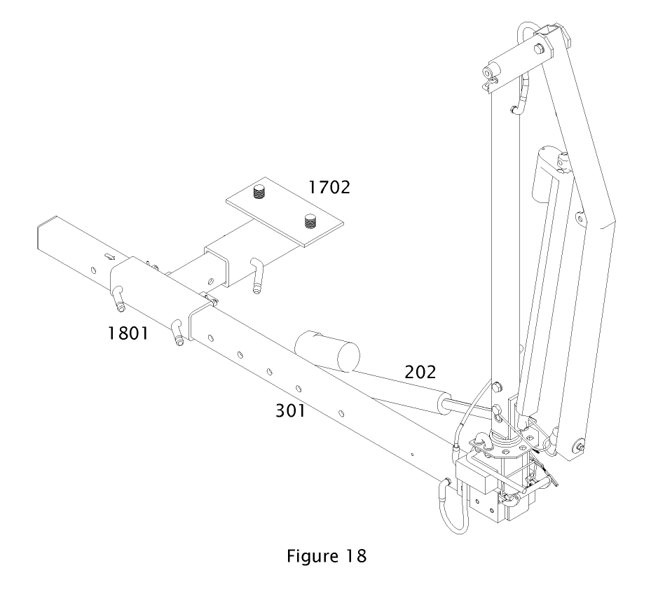

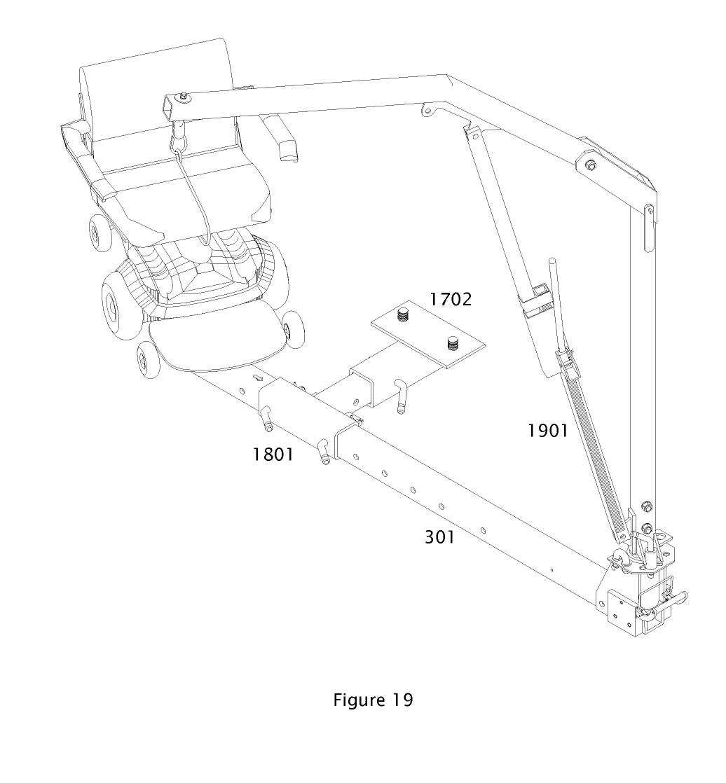

This invention is useful for groceries, portable shopping carts, wheel-chairs, and heavier items such as logs, motorcycles, engines, lawn tractors, garbage receptacles, and pallets. FIG. 9 shows a method to use a wireless remote to cause a mechanically powered embodiment the invention to lift a powered mobility device 901. By contrast FIG. 19 shows a powered mobility device operatively coupled to an embodiment of the present invention that relies on a mechanically operated jack 1901 to induce lifting movement. FIG. 10 shows a portable cart 1001 that is being lifted into the trunk of a vehicle by an embodiment of this invention. If a host vehicle has limited storage space, it may be useful to combine this invention with a dual receiver hitch 1101 and a receiver hitch tray 1102.

This invention can be scaled to accommodate any load of any size or weight that is safe to engage onto or into the host vehicle. FIG. 12 shows how this invention can be used to transfer an engine 1201 from one vehicle to another. A preferred embodiment for moving large objects in tow employs a bent jig 1202 and a plurality of wheels 1203 to stabilize the hoist and load while it is in tow. Among the numerous embodiments and methods of use, this invention can be used to move items from one vehicle to another or from a vehicle to a loading dock. Various adaptations of the hoist can be used to lift larger objects like pallets 1301 of cargo 1302. It is best to use a pallet or other adapter 1401 when lifting bulky items such as lawn mowers, small watercraft, motorcycles, or ATVs 1204 onto a vehicle.

While a principal motivation of this invention is to enable a vehicle to lift items from the ground, the invention is also able to lift smaller items up and out of the vehicle to an elevation that makes it easier for a person to retrieve them.

It is understood that the above embodiments and applications are merely illustrative of the possible specific applications which may represent principles of the present invention. Other arrangements may readily be devised in accordance with the principals herein by those skilled in the art without departing from the scope and spirit of this invention. For example electric switches, computer or microprocessor control, electronic control, other methods, and preferably wireless control 902 may be used to effect movement throughout select embodiments of this invention. Likewise alternative methods to affix the hoist embodiments described herein to a vehicle are also possible.

What is claimed is:

1. A retractable lifting apparatus with folding hinge and pivoting points optimally placed to reduce the size of the retracted state thereof, a means to optionally engage linear motion actuation components capable of pivoting with lifting operations thereof, and comprises in combination:
(a) a mechanical means to releasably engage a vehicle insert that is sized and shaped to receive said retractable lifting apparatus,
(b) a mechanical means to vertically move a load relative to said lifting apparatus,
(c) a mechanical means to pivotally rotate a load relative to said lifting apparatus,
(d) a mechanical means to alternate said lifting apparatus between operable and retracted states.

2. A lifting apparatus of claim 1 that further comprises a mechanically powered means to induce folding of said lifting apparatus into said operable and retracted states.

3. A lifting apparatus of claim 1 that further comprises a mechanically powered means to cause said pivotal rotation of said load relative to said lifting apparatus.

4. A lifting apparatus of claim 1 that further comprises a jig to support said lifting apparatus relative the surface below thereof and further comprises in combination:
(a) a plurality of components of said jig extendable and retractable to accommodate various distances between the said lifting apparatus and the surface below thereof,
(b) a plurality of wheels, casters, or other rolling apparatuses optionally coupled to said jig.

5. A lifting apparatus of claim 1 that further comprises a plurality of locks releasably engaged to control pivotal movement throughout said lifting apparatus.

6. A lifting apparatus of claim 1 that comprises a means to tightly engage said lifting apparatus to said vehicle insert and further comprises in combination:
(a) a structural gap at the engagement point end of said lifting apparatus,
(b) a mechanical means to alter the physical dimensions of the engagement point of said lifting apparatus by releasably engaging a plurality of components that cause expansion and relief thereof.

7. (canceled)

8. A lifting apparatus of claim 1 that further comprises in combination:
(a) a plurality of electric switching means optionally coupled to said lifting apparatus to control actuation of mechanically powered components thereof,
(b) a plurality of electric sensor means optionally coupled to said lifting apparatus to control actuation of mechanically powered components thereof,
(c) a plurality of wirelessly controlled switching means optionally coupled to said lifting apparatus to control actuation of mechanically powered components thereof,
(d) a plurality of software controlled switching means optionally coupled to said lifting apparatus to control actuation of mechanically powered components thereof.

9. (canceled)

10. (canceled)

11. (canceled)

12. (canceled)

13. (canceled)

14. An apparatus of claim 1 that further comprises a means to releasably couple human and mechanically powered accessories to induce movement throughout said lifting apparatus.

15. (canceled)
